(19) United States
(12) Patent Application Publication
(10) Pub. No.: US 2006/0230027 A1
(43) Pub. Date: Oct. 12, 2006

(54) Apparatus and method for utilizing sentence component metadata to create database queries

(76) Inventors: Nicholas Guy Kellet, Kelowna (CA); Richard David Webster, Vancouver (CA)

Correspondence Address: COOLEY GODWARD, LLP, 3000 EL CAMINO REAL, 5 PALO ALTO SQUARE, PALO ALTO, CA, 94306, US

(21) Appl. No.: 11/102,477

(22) Filed: Apr. 7, 2005

(51) Int. Cl. G06F 17/30

(52) U.S. Cl. 707/3

(57) ABSTRACT

A computer readable medium includes executable instructions to associate text sentence components with metadata. The executable instructions specify a subject that has a definition corresponding to a metadata source. The executable instructions identify a behavior that has a definition corresponding to a metadata source. The behavior is associated with at least one subject. The behavior and at least one subject allow a user to create a text question convertible to a query to a data source associated with the metadata source.

### CROSS-REFERENCES TO RELATED APPLICATIONS

This application is related to the following concurrently filed, commonly owned patent applications, each of which is incorporated by reference herein:

Apparatus and Method for Deterministically Constructing a Text Question for Application to a Data Source, Ser. No. ______, filed Apr. 7, 2005;

Apparatus and Method for Modeling Business Logic, Ser. No. ______, filed Apr. 7, 2005; and

Apparatus and Method for Constructing Complex Database Query Statements Based on Business Analysis Comparators, Ser. No. ______, filed Apr. 7, 2005.

### BRIEF DESCRIPTION OF THE INVENTION

This invention relates generally to accessing digital data. More particularly, this invention relates to a technique for creating a layer of metadata based on the concepts of subject, behavior and measure that can be used to transform text questions into database queries.

### BACKGROUND OF THE INVENTION

Business Intelligence generally refers to software tools used to improve business enterprise decision-making. These tools are commonly applied to financial, human resource, marketing, sales, customer, and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by Business Intelligence tools and the vast amount of data that they are applied against, there are ongoing efforts to simplify their use. In their most successful manifestations, non-technically trained personnel can use Business Intelligence tools. To achieve this, it is important to insulate non-technically trained personnel from the complexities of the underlying data sources. Users of Business Intelligence tools generally have knowledge of the information that they want; the challenge is translating this knowledge into appropriate queries that can be applied to an underlying data source.

Ideally, a Business Intelligence tool provides an interface that allows a user to think on his or her own terms, but still allows for data source queries (e.g., database queries) that can be efficiently applied against a data source. Metadata is often used in strategies to simplify access to a data source, but often this metadata adds another level of complexity rather than providing accessible conceptual metaphors that can be readily understood by novice end users without learning about the logical structure of the metadata. Since Business Intelligence users commonly think in terms of subjects (such as products, employees, stores, regions), behaviors (such as selling, buying, shipping, hiring, responding, owing), and measures (such as revenue, units sold, quantity invoiced, profit) it would be desirable to provide such users with a metadata framework that allows them to select specific meaningful subjects, behaviors, and measures in order to shape how they create high level questions to access a data source or multiple data sources. Ideally, such a system would enable the creation of shared metadata domains that would enable a novice end user to construct a range of high level seemingly straightforward business questions against multiple underlying data sources without requiring that the novice end user understand the structure or complexity of the underlying data.

### SUMMARY OF THE INVENTION

The invention includes a computer readable medium with executable instructions to associate text sentence components with metadata. The executable instructions specify a subject that has a definition corresponding to a metadata source. The executable instructions identify a behavior that has a definition corresponding to a metadata source. The behavior is associated with at least one subject. The behavior and at least one subject allow a user to create a text question convertible to a query to a data source associated with the metadata source.

The invention includes a category of metadata structures based on the concepts of subject, behavior, and measure and the process to construct these metadata structures. Each metadata structure that is constructed can then be used and re-used in other applications by novice end users to share a foundation for constructing a wide range of queries based on an accessible logical structure. These queries based on the metadata can then be used to query the data source and perform further functions, such as generating reports.

The invention enables the construction of a metadata structure (or question domain) based on a simple set of easily understood logical relationships (e.g., subject, behavior, and measure). An intermediate user who has some understanding of the data content in the underlying data sources, but who does not have programming skills (e.g., SQL programming skills) may create a question domain. This intermediate user is guided by a graphical user interface (GUI) that provides logical information based on the contexts and constraints in the underlying data source and enables the intermediate user designing the question domain to construct subjects, behaviors, and measures. In this way, the question domain designer's knowledge about the underlying data is encapsulated in subject, behavior, and measure relationships that can be readily understood by more novice users who do not have knowledge about the underlying data source. Question domains can be saved locally or be published within repository systems. They can also be easily updated and republished. Based on the question domain that has been designed, novice end users are able to easily construct a wide range of business questions with no knowledge of the specifics of the underlying data. The invention includes an illustrative end user GUI tool that enables novice end users to access question domains and use them to create high level questions that are used to generate database queries and to construct reports.

The question domain is constructed on top of a data source, referred to as the Primitive Metadata Domain or Primary Metadata Domain (PMD). The data source contains a layer of metadata that at a minimum should identify the data objects, table joins, aggregated measures, and optionally may identify date objects, table join sets (also called contexts) and filters. Examples of primitive metadata domains that contain the required metadata include Business Objects Universes or Business Views, which are commercially available from Business Objects Americas, San Jose, Calif. In the case of a data source, such as a relational database schema, that does not contain this metadata, an intermediary adapter layer is constructed.

The invention also includes a computer readable medium storing executable instructions to construct the metadata for the question domain. The executable instructions include executable instructions to supply the user with information about a primary metadata domain that is selected including the data that is contained within the data source and any context information that may be available for the data. The user is allowed to select one or more underlying primitive metadata domains to use as the basis for the question domain metadata. The user is allowed to construct a subject or multiple subjects within the question domain metadata. A subject may be connected to one or more underlying primitive metadata domains. The user is allowed to construct a behavior or multiple behaviors. Each behavior is associated with a single underlying primary metadata domain. The user is then able to associate a behavior with a subject or multiple subjects in order to construct logical relationships. This metadata can be saved to a computer readable medium and accessed by other users and other programs. The invention provides a set of logical relationships for defining overarching relationships in complex business data so that questions can be constructed using relationships and terms that are familiar to all types of end-users. Advantageously, the invention supplies metadata that abstracts the query logic so that end users can construct complex business questions based or accessible logical relationships without needing to understand the structure of the underlying data.

### BRIEF DESCRIPTION OF THE FIGURES

The invention is more fully appreciated in connection with the following detailed description taken in conjunction with the accompanying drawings, in which:

FIG. 1 illustrates the general process flow for creating and using a question domain configured in accordance with an embodiment of the invention.

FIG. 2 illustrates the structure and abstraction of question domain metadata in accordance with an embodiment of the invention.

FIG. 3 illustrates the structure of specific connections to underlying primary metadata domain.

FIG. 4 illustrates an exemplary set of relationships constructed within metadata based on two primitive metadata domains and how the subjects, behaviors, and measures connect.

FIG. 5 illustrates a GUI used to construct a question domain that will contain specifications for subjects, behaviors and relationships between subjects and behaviors.

FIG. 6 illustrates an exemplary GUI used to construct a subject within a question domain.

FIG. 7 illustrates an exemplary GUI used to construct a behavior.

FIG. 8 illustrates an exemplary GUI for associating a measure with a behavior.

FIG. 9 illustrates an exemplary GUI for associating a date object with a behavior.

FIG. 10 illustrates an exemplary GUI for associating a filter with a behavior.

FIG. 11 illustrates an exemplary GUI for constructing a subject when a question domain contains more than one primary metadata domain.

FIG. 12 illustrates an exemplary GUI for constructing a subject when a question domain is constructed with more than one primary metadata domain.

FIG. 13 illustrates a range of questions that a novice end user can construct based on a very simple question domain.

FIG. 14 illustrates an exemplary GUI for returned query results.

FIG. 15 illustrates a network configured in accordance with an embodiment of the invention.

Like reference numerals refer to corresponding parts throughout the several views of the drawings.

### DETAILED DESCRIPTION OF THE INVENTION

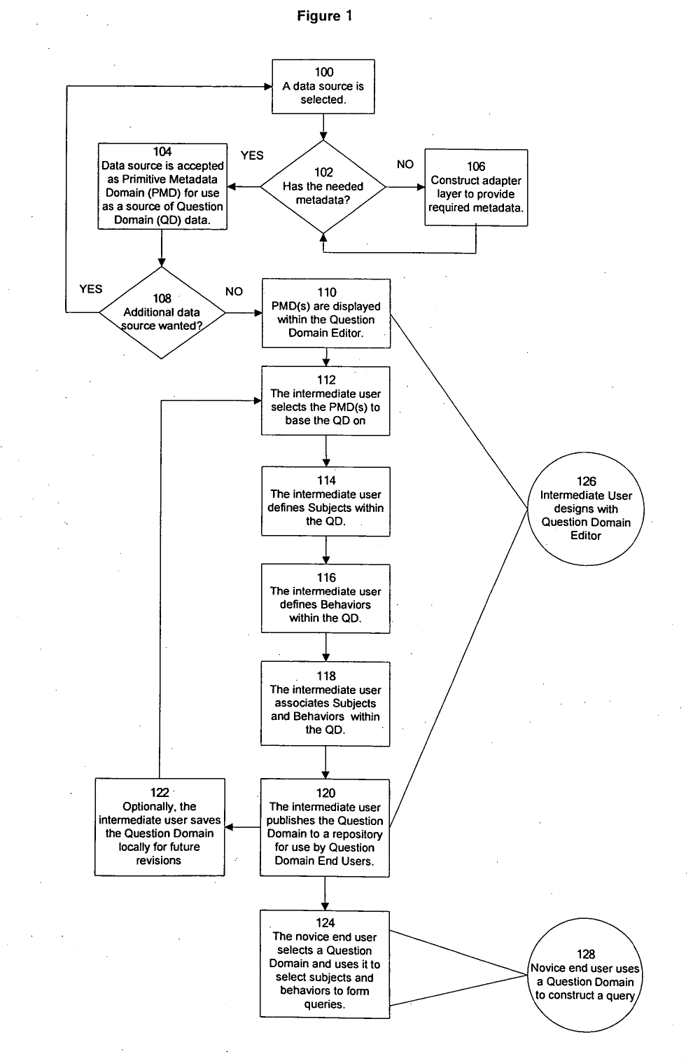

FIG. 1 illustrates an exemplary process for creating and using question domains. The process starts with a data source being selected 100 and leads to a decision whether the data source contains the required metadata 102. At a minimum, the metadata should identify data objects, joins, and aggregated measures. The metadata may also optionally identify date objects, contexts and filters. If the data source contains sufficient metadata, the data source is accepted as a primitive metadata domain (PMD) 104. If there is insufficient metadata, the required metadata 106 is constructed, for example, by using an adapter layer.

After the data source has been accepted, either directly or with an adapter layer, it is determined whether an additional data source is desired 108. Additional data sources that are selected 100 are validated 102 to confirm that they contain the required metadata. After the primitive metadata domains are specified, they are displayed in a question domain editor, indicating availability for use as a data source to construct question domains 110. A question domain designer (e.g., an intermediate user) selects available primitive metadata domains for a question domain 112. Subject(s) within the question domain are specified 114. Next, behavior(s) 116 are specified. Subjects and behaviors are then associated within the question domain 118. The question domain is published to a repository 120 so that it is available for other users. Optionally, the question domain is saved 122 and the processing of blocks 112 through 120 is repeated. At this point, a novice end user may select the created question domain and use it to construct queries 124 using simple logical relationships.

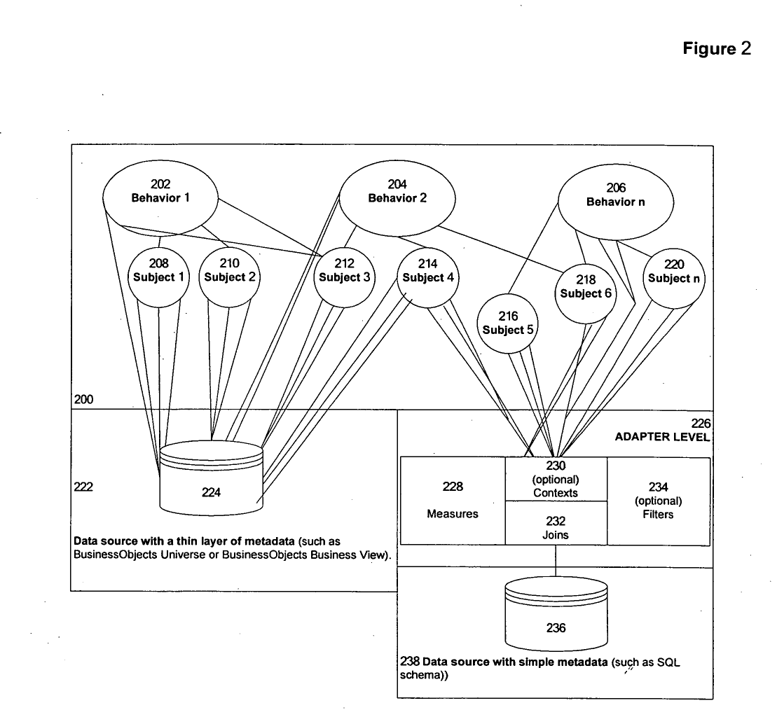

FIG. 2 illustrates a question domain metadata system. The question domain can be based on a data source with a thin layer of metadata 224 such as a Business Objects Universe or Business View, as commercially sold by Business Objects Americas, San Jose, Calif. The question domain can also be based on a simple data source 236 with an adapter layer 226. This data source 224 with a thin layer of metadata, or primitive metadata domain, contains at a minimum data objects, joins, and aggregate measures. Optionally, it may contain date options, contexts, and filters. If the underlying data source does not have the required metadata 236, an adapter level 226 may be used to provide metadata. The simple data source 236 and the adapter level 226 together constitute a primitive metadata domain 224 in the system. In one embodiment, the adapter layer 26 has measures 228 and joins 232 and may include other metadata, such as contexts 230 and filters 234.

On top of the primitive metadata domain 224 or equivalent combination of a simple data source 236 an adapter level 226, the metadata layer, referred to as the question domain, 200 is constructed. The question domain metadata layer 200 is constructed based on the concepts of behaviors 202, 204, 206 and subjects 208, 210, 212, 214, 216, 218, and 220.

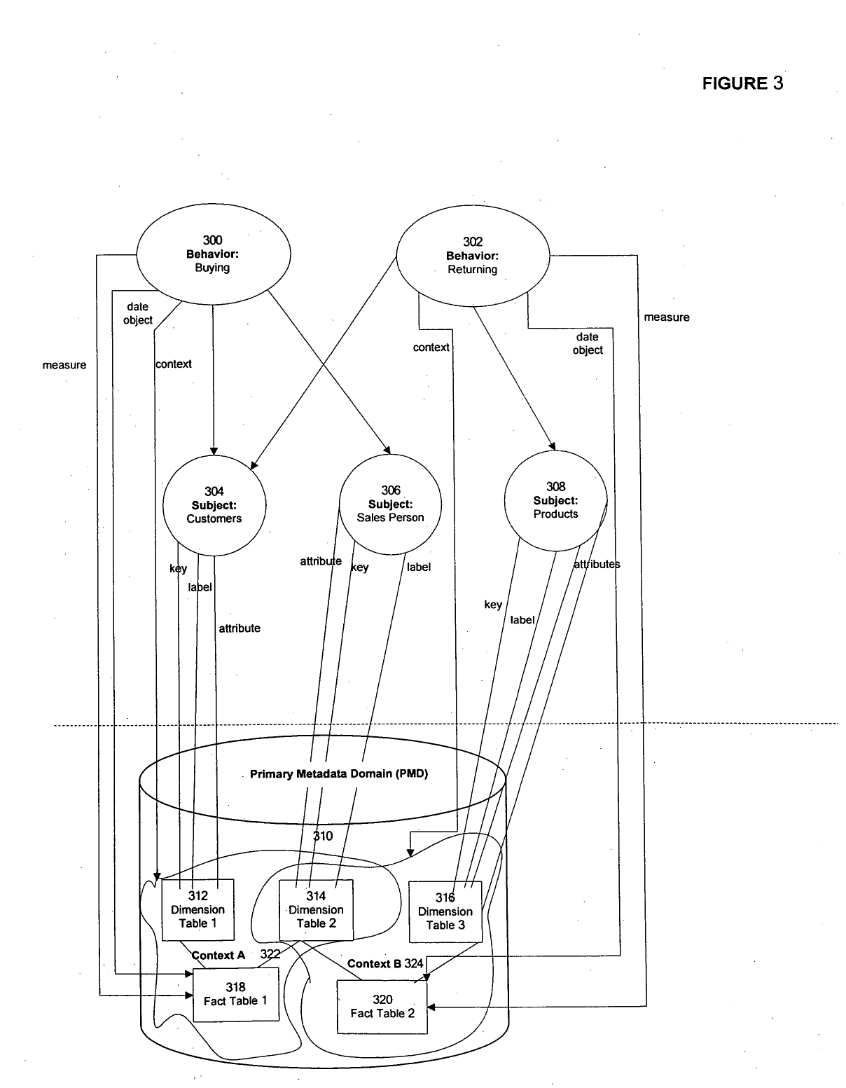

Subjects are linked to the underlying data based on keys, labels, and attributes as is shown in detail in FIG. 3. Subjects can be defined against multiple underlying data sources as is shown with subject 214 of FIG. 2. Behaviors are linked to one or more subjects. Behaviors also link to the underlying data source for measures and date objects, as is shown in FIG. 3. A behavior links to a single data source. Although a behavior can connect to multiple subjects, each of the subjects is connected to the same data source as the behavior.

FIG. 3 illustrates how contexts (defined join set preferences) 322, 324 in the underlying primitive metadata domain 310 affect the structure of the metadata. Within the depicted primitive metadata domain 310 there are three dimension tables 312, 314, 316 and two fact tables 318, 320. Based on the potential joins between the tables, join sets have been defined such that dimension tables 312, 314 and fact table 318 are together in context A 322. Dimension table 314 is also in context B 324 with dimension table 316 and fact table 320. These tables are joined together logically. By providing a context, the primitive metadata domain specifies which join relationships will be used when connecting data. A subject can be compatible with more than one context, as is depicted with subject 306. In fact, as illustrated in FIG. 2, a subject 214 can be defined based on more than one underlying data source. Behaviors can contain subjects that are defined in multiple data sources and multiple contexts, but they themselves can only link directly to data for measures and date objects that exist within a single data source and, if contexts are defined, within a single context within the data source.

Also illustrated in FIG. 3 are connections between subjects 304, 306, 308 and the dimension tables 312, 314, 316. For each subject, a key and a label are identified within an underlying dimension table. (Depending on the underlying data structure, the key and the label may refer to the same data element.) In addition to the key and the label, attributes for the subject may be specified. In the simplest case, date objects and measures for a behavior are defined by columns in a fact table or may be defined using an expression that can be related to a fact table.

In FIG. 3, behavior 300 is defined against context A 322. The measure and date object for behavior 300 are contained in fact table 318. Therefore, both the measure and the date object exist within the same context A 322. A date object from fact table 320 could not be an aspect of behavior 300 because it exists only within context B 324, which is not the context that is used to define behavior 300. If no contexts are specified within the primitive metadata domain 310, behaviors are simply restricted to a single underlying data source.

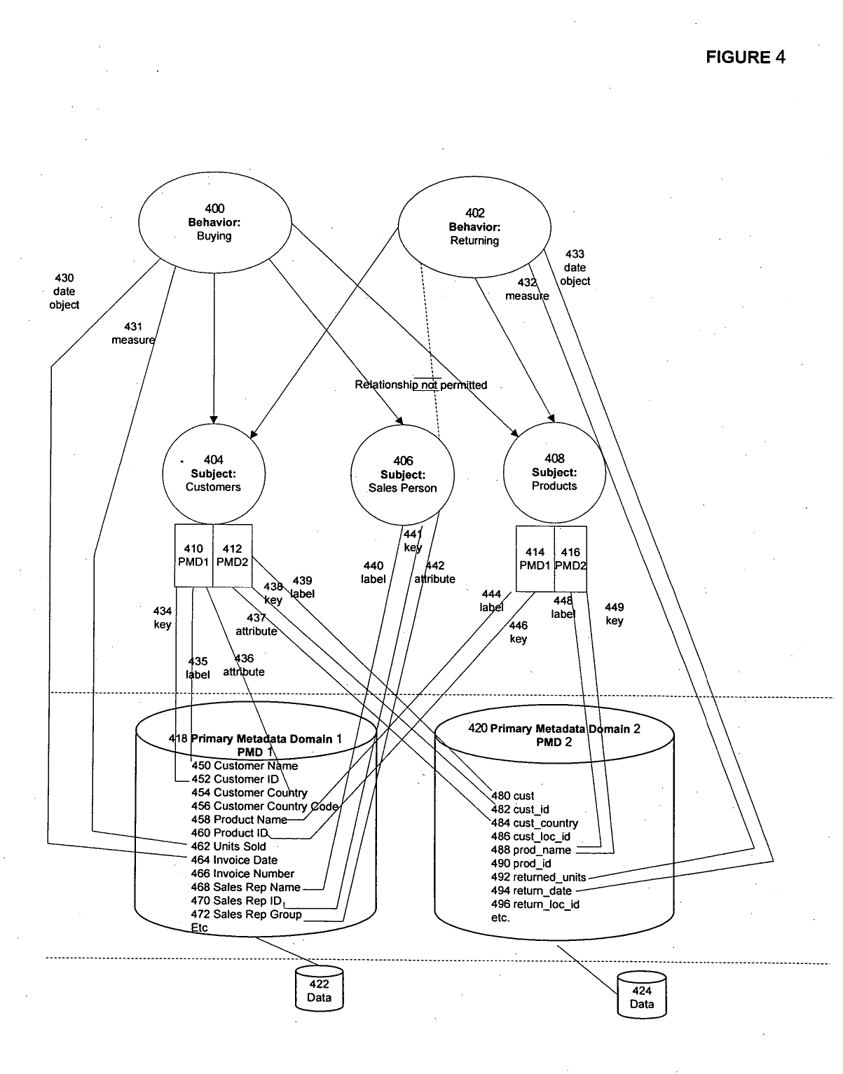

FIG. 4 illustrates a specific set of relationships constructed within metadata based on two primitive metadata domains and how subjects, behaviors, and measures connect. This figure shows a question domain in which there are two defined behaviors: buying 400 and returning 402. The buying behavior 400 connects to all three subjects: customers 404, sales person 406, and products 408. A subject can be referred to by more than one behavior. In this example, both the buying 400 and returning 402 behaviors refer to the subject customers 404. For the behavior returning 402 there are only connections to customers 404 and products 408. Presuming that the underlying data source provides logical joins and context information, a relationship to sales person would not be permitted, as it does not fit with data for products being returned. Both behaviors and subjects have references to members of primitive metadata domains. For example, subject 404 references a key 434, label 435, and attribute 436 in primitive metadata domain 418 and a key 438, label 439, and attribute 437 in primitive metadata domain 420. Behavior 400 has a reference to a date object 430 and measure 431 in only one primitive metadata domain 418.

Although not illustrated, multiple measures and multiple date objects can be defined for a behavior. A behavior only links directly to one of the underlying data sources. In this figure, behavior 400 is shown as connecting to primitive metadata domain 418 for both measure 431 and date object 430. Behavior 400 does not connect to 420 for additional measures or date objects. In this example, buying behavior 400 has a date object 430 that links to invoice date in the primitive metadata domain and a measure 431 that links to units sold 462 in the primitive metadata domain. The measure is required, but specifying date objects is optional.

Within the question domain there are three subjects: customers 404, sales person 406 and products 408. Two of the subjects, customers 404 and products 408, are defined against two underlying primitive metadata domains 418 and 420. The other subject, sales person 406, is defined against only one primitive metadata domain 418. To connect to more than one primitive metadata domain, a subject is defined for each of the primitive metadata domains with key, label and attribute information specific to each underlying primitive metadata domain.

The subject customers, links to primitive metadata domain 418 using the key 434 linked to customer ID 452. The label 435 is linked to customer name 450. The attribute 436 is linked to customer country 454. If the underlying primitive metadata domain does not include distinct elements for both a key and a label, the same element can be used for both the key and the label. One or more attributes can be specified for the subject.

Below the primitive metadata domains 418 and 420 are the original data sources 422 and 424. This figure illustrates the three layers that are involved in the invention: the question domain level that contains the behaviors and subjects, the primitive metadata domain level, and the underlying data sources.

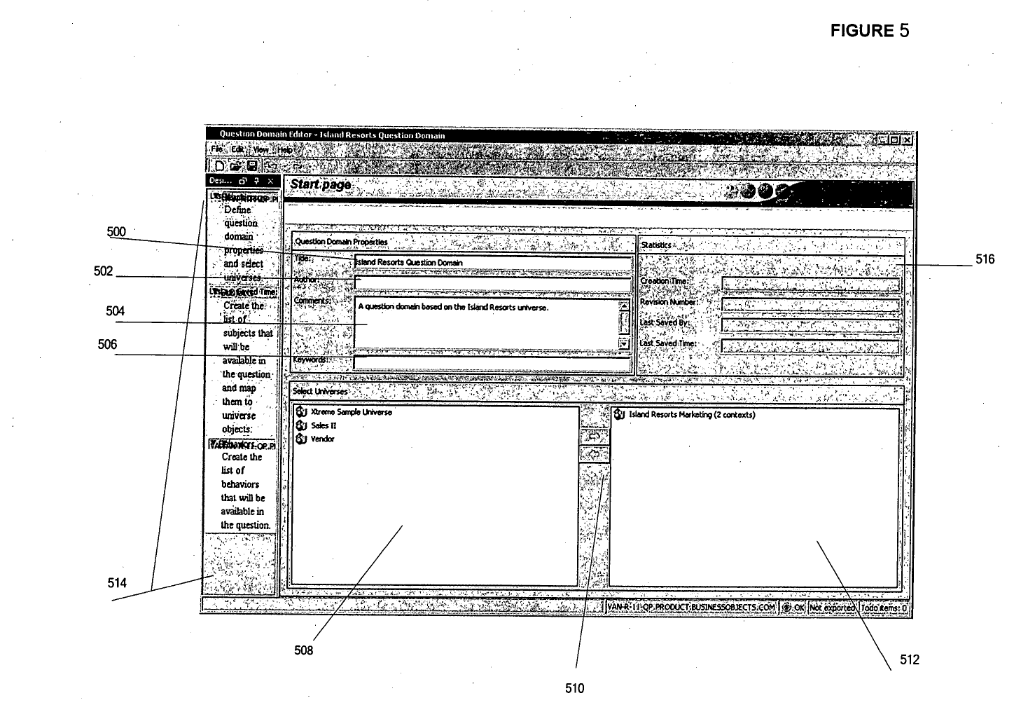

FIG. 5 illustrates a GUI used to construct a question domain with subjects, behaviors and relationships between subjects and behaviors. On this “Start Page” an intermediate user who is designing the question domain provides information for the question domain properties, such as title 500, author 502, comments 504 and keywords 506. From the primitive metadata domain selection panel 508, the designer can use the arrow 510 to select which primitive metadata domains will be available within the question domain 512.

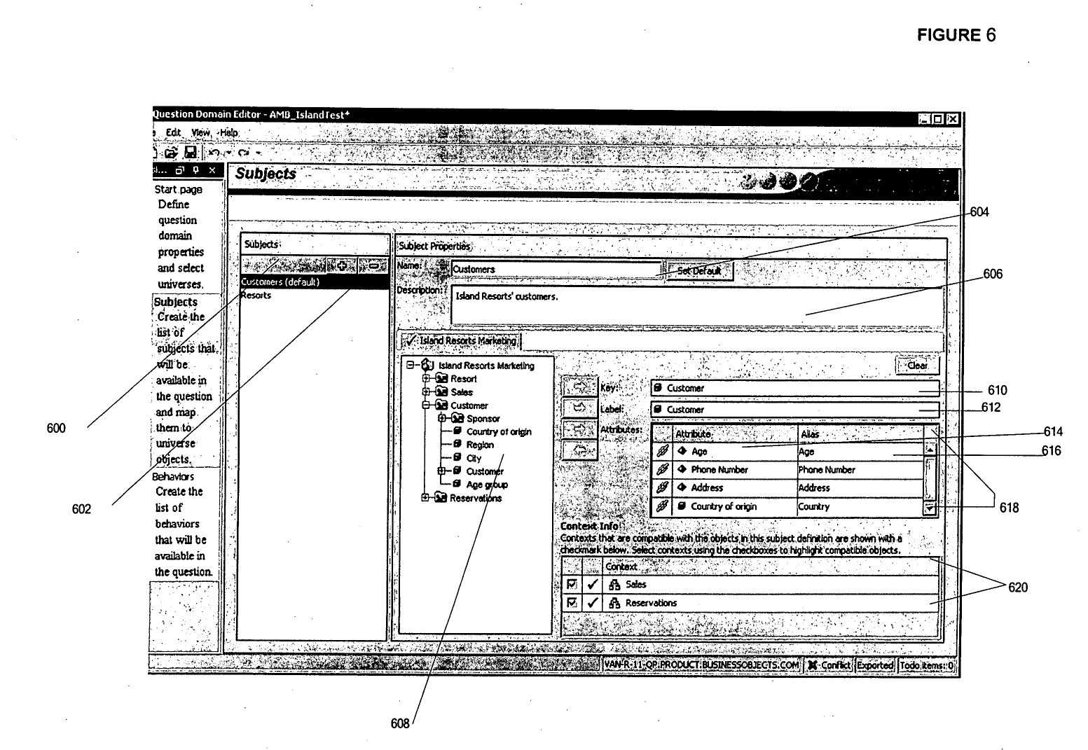

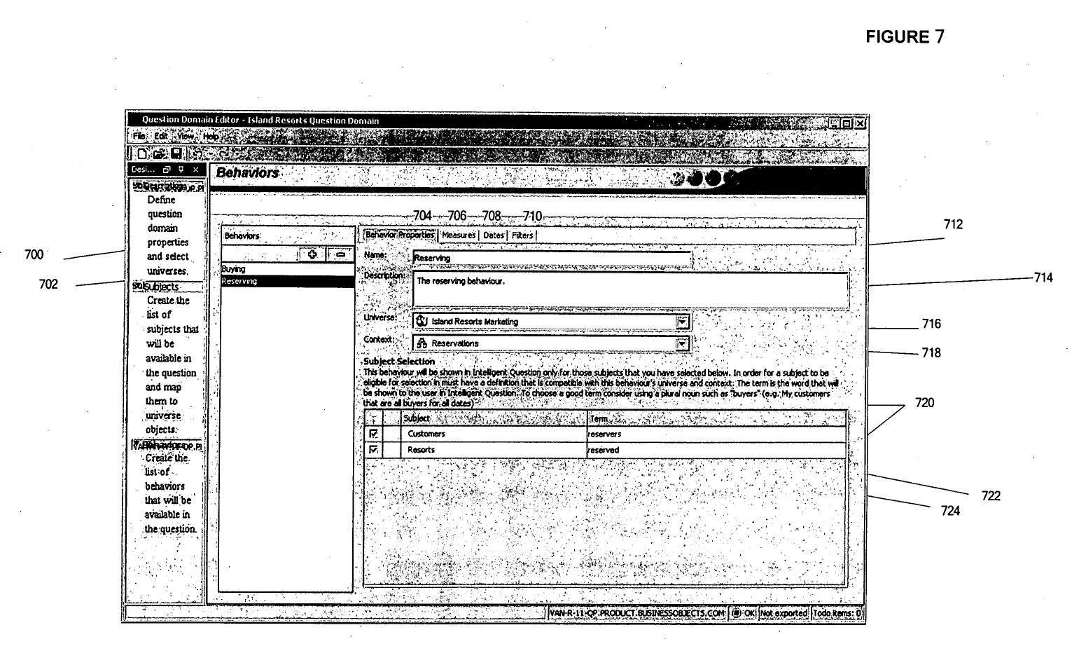

FIG. 6 illustrates a GUI used to construct a subject within the question domain. Subjects are generally identified before behaviors, but there is no GUI constraint and the user can move between the “Start Page” of FIG. 5, the “Subject Page” of FIG. 6, and the “Behavior Page” of FIG. 7, by clicking on the left hand tool bar 514. On the subject page the user sees pre-identified subjects in the subject section 600 and can use the plus and minus buttons 602 to add and remove subjects. The subject is provided with a name 604, and optionally a description 606. Then, selecting based on the primitive metadata domain data that is displayed 608, the user can add elements from the primitive metadata domain for the key 610 the label 612 and attributes 614-618. The key 610 is used to determine the result items. The label 612 specifies which field will be displayed to the user within the GUI. Often it may be desirable to specify a key based on an ID field and a label based on a name based field. The attributes 618 provide additional information about the subject. If the data field has a name 614 that is not suitable for display purposes an alias 616 can be manually specified. The alias 616 is also used to connect subject attributes between different underlying primitive metadata domains. Context information from the underlying primitive metadata domain is displayed in section 620 and the user can select which context(s) they want to use for the subject.

FIG. 7 illustrates the GUI used to construct a behavior. The behavior page has several tabs to access sub-pages where measures 706, dates 708, and filters 710 can be associated with the behavior. On the behavior page, the user sees pre-identified behaviors in the behavior section 700 and can use the plus and minus buttons 702 to add and remove subjects. A name 712 and optionally a description 714 can be specified for the behavior. Every behavior is linked to one primitive metadata domain 716 (referred to as a Universe within the GUI) and one context 718 within the primitive metadata domain. The designer can select these using the pull down menu. The designer can then specify which subjects are associated with the behavior. For each subject that is associated with a behavior, the user specifies a term so that the subject can more easily be understood within the context of the behavior. In this case, where the behavior is reserving, the subject customers is identified with the term reservers and the subject resorts is identified with the term reserved. An additional behavior, buying, can be defined to differentiate between reservations and revenue that has been received. These behaviors and the terms assigned to the subjects for the behavior appear in the GUI that a novice end user may use to construct the question.

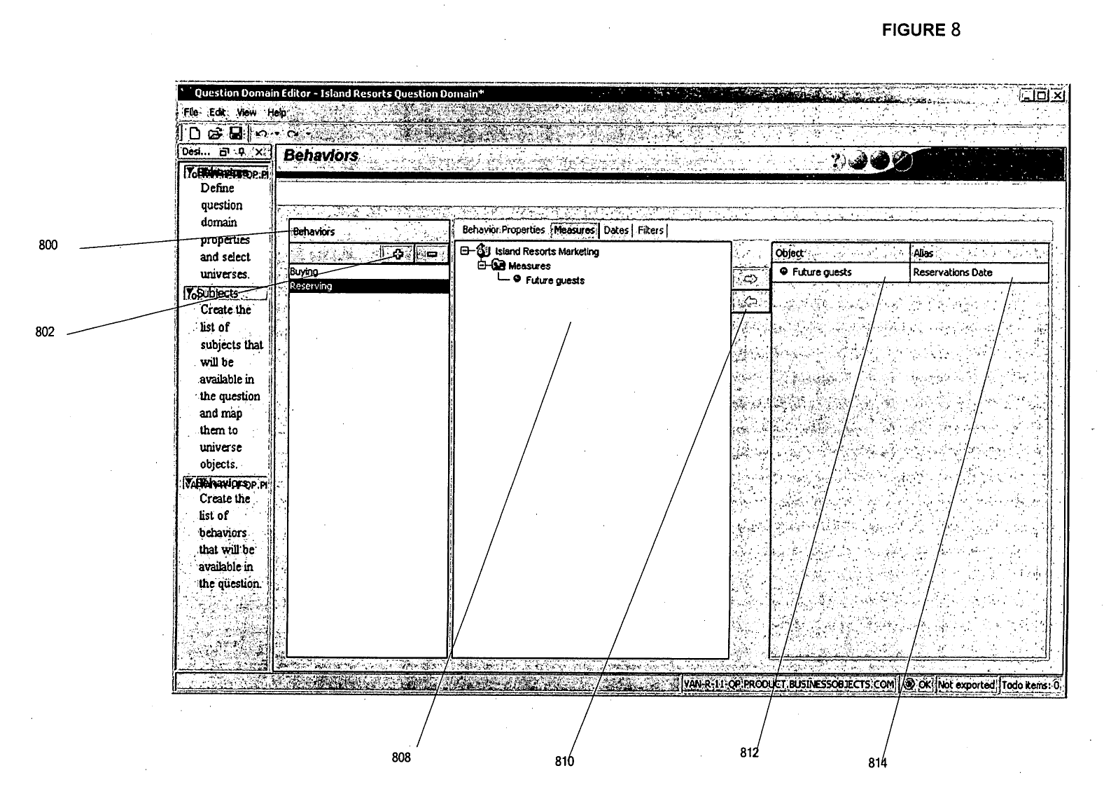

FIG. 8 illustrates a GUI for associating a measure with a behavior. Measures are selected from a list of measures available from the primitive metadata domain displayed 808 using the arrow buttons 810. The name of the selected measure object is displayed 812. An alias 814 to be displayed in the end user GUI can be manually specified. Measures are defined in the underlying primitive metadata domain and are used to quantify the behavior.

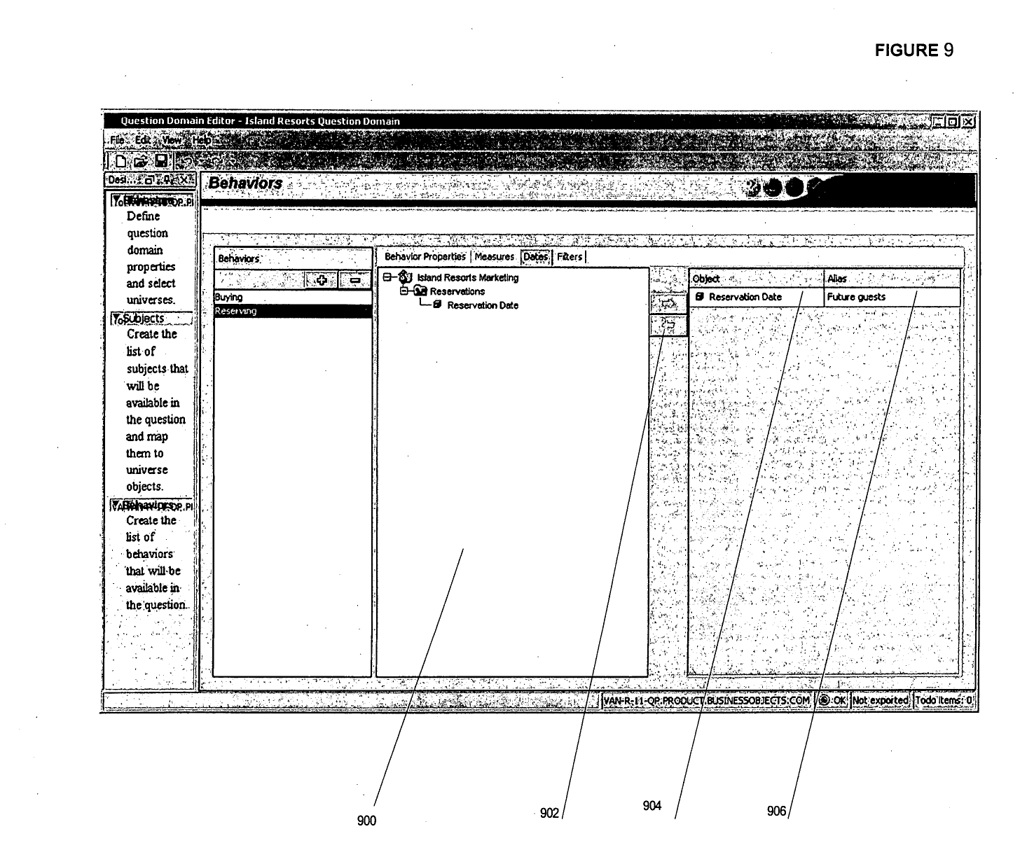

FIG. 9 illustrates a GUI for associating a date object with a behavior. Using the arrow buttons 902, date objects are selected from the list of date objects in the displayed primitive metadata domain 900. The name of the selected date object is displayed 904. An alias 906 can be manually specified. Date objects are defined in the underlying primitive metadata domain and are used to associate the behavior with specific time and date ranges.

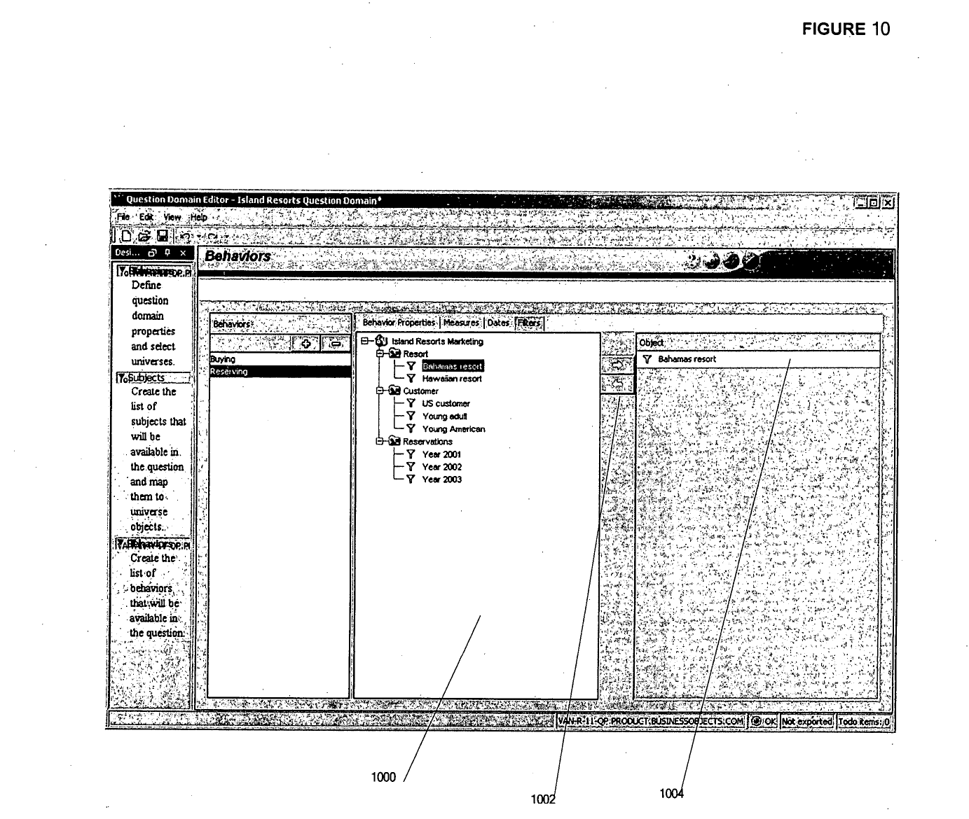

FIG. 10 illustrates a GUI for associating a filter with a behavior. Using the arrow buttons 1002, filters are selected from the list of filter objects available from the displayed primitive metadata domain 1000. The name of the filter object is displayed 1004. A filter object specified for a behavior is applied when a behavior is used. One common use of filters is for selecting a specific transaction type from a transaction table when the behavior's data includes a transaction table with mixed content. Applying a filter to a behavior allows the designer to provide the novice end user with a question domain with appropriate data.

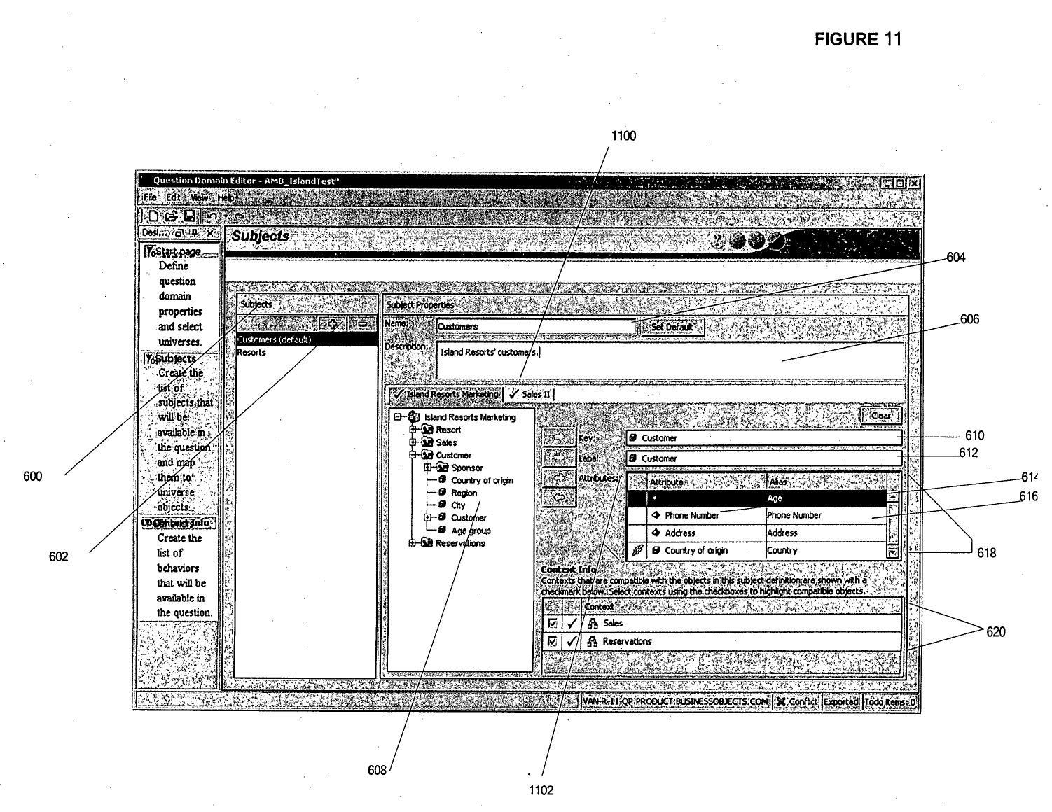

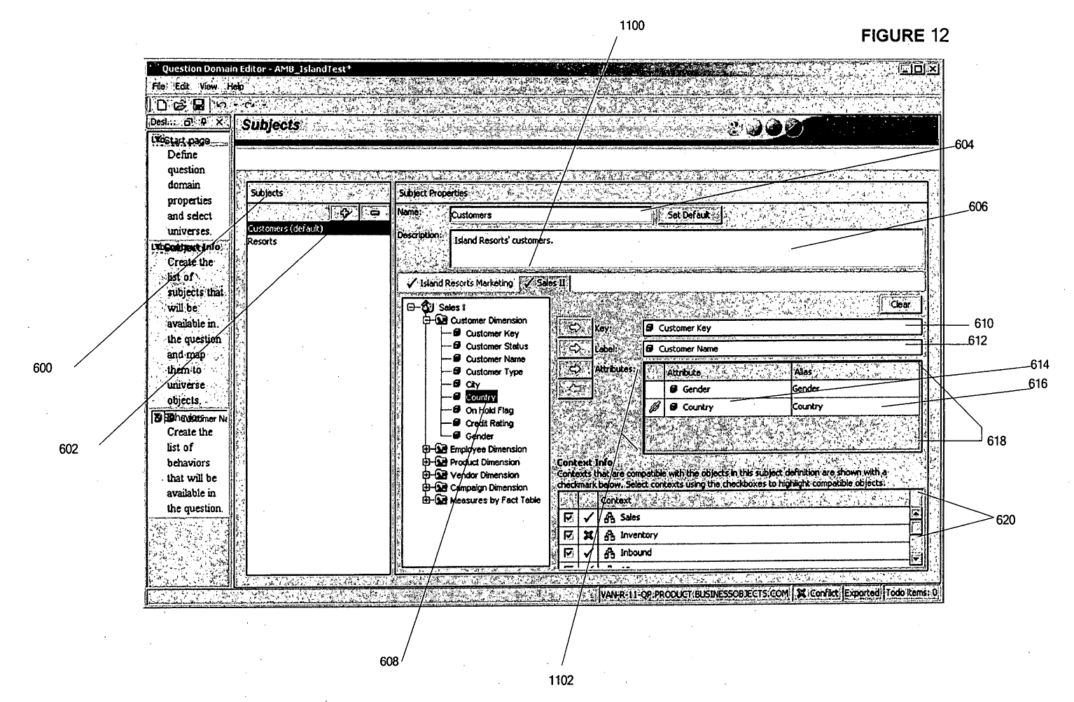

FIG. 11 illustrates the GUI for constructing a subject when the question domain contains more than one primitive metadata domain. As illustrated in FIG. 5, one or more primitive metadata domains can be selected for inclusion within the question domain. Originally, only the “Island Resort Marketing” primitive metadata domain was selected, but returning to the start page, the Sales II primitive metadata domain was added to the question domain. Now, in FIG. 11 the GUI to add a subject (originally illustrated in FIG. 6) has an additional tab 1100 and the connection status of the attributes 1102 (indicated in the first column of the attribute table 618) has changed. In FIG. 6, all of the attributes showed the connection symbol (chain link), but now only the attribute country of origin with the alias country has the connection symbol. The reason for this change becomes clear when we see the second tab that defines the subject customers against the primitive metadata domain sales II in FIG. 12.

FIG. 12 illustrates a GUI for constructing a subject when the question domain is constructed with more than one primitive metadata domain. In FIG. 12 the tab 1100 indicates that the subject, customers, is defined based on the Sales II primitive metadata domain. Field 608 displays the data from the Sales II primitive metadata domain that can be used to specify the key 610, label 612, and attributes 618. A different data element is selected for the key and label, based on the data that is available in the Sales II primitive metadata domain. Note that the only attribute that is connected between the definitions for customer in the two primitive metadata domains is the country attribute. In FIG. 11, the attribute “Country of Origin” had the alias “Country”, which matches the alias for attribute “Country” from Sales II. The connection is established by providing the same alias for both attributes and is indicated in the GUI by the connection symbol. When a novice end user constructs a query based on this subject, all of the attributes defined for customers (age, phone number, address, gender and country) can be displayed, but only the linked attribute country will be available as selection criteria for filtering the query. The contexts section 620 for Sales II contains the different contexts that are defined within this primitive metadata domain.

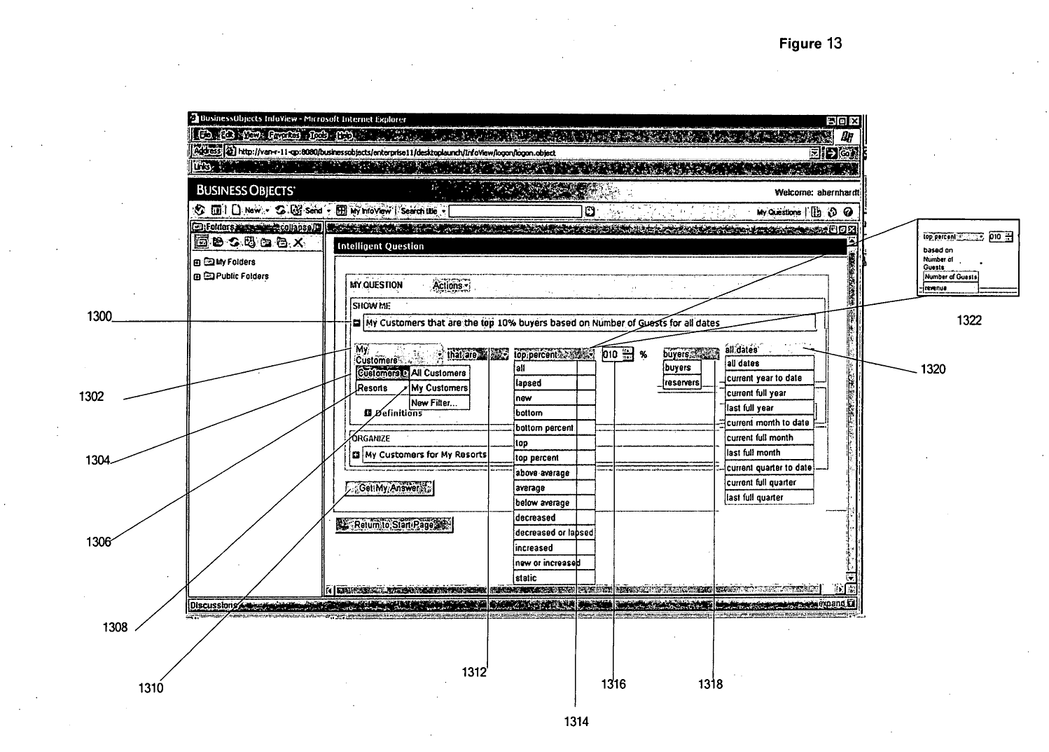

FIG. 13 illustrates questions that a novice end user can construct based on a simple question domain. The imported question domain corresponds to the question domain defined in FIGS. 5 through 12. The novice end user has the option to choose which available question domain to use to construct a query, and then to choose subjects and behaviors to shape the query. The subject 1302 can be either customers 1304 or resorts 1306 (these were defined in the question domain). Additionally, the novice end user can construct a filter for “My” subjects 1308 based on the linked attributes that are available. In this case, the user filters customers based on whether their country attribute was within the user's sales district.

The novice end user can construct other personal filters for the subject 1308. Then the user can determine whether the results returned will be for subjects “that are” or “that are not” 1312 within the specified range. Then the novice end user can select one of many of the provided comparators (or question styles) that determine the method of selecting the values for the subject. For example, the comparator may specify whether the subject is top n, bottom, new, all, etc. 1314. The user also specifies the measure 1322, in this case deciding between number of guests or revenue.

The measures were selected for behaviors in FIG. 8. Depending on which behavior the question refers to, the relevant measures will be available. In addition to the measure, the user specifies any other values required by the comparator to determine which data should be returned. In this case, a value 1316 for top percent is specified as 10%. The user then selects the behavior term for the subject. In this case rather than selecting the term “reservers” that was defined in FIG. 7 for customers related to the reserving behavior, the term “buyers” from the buying behavior is selected. Finally, based on the available date objects for the behavior, the novice end user can select a time/date range 1320. By default, a functional question against the question domain will be formed in the question GUI, and the user will modify this question within the GUI restraints, which prevent an invalid question from being formed at any point. When the user is done specifying the question (i.e., identifying which attributes and values for measures will be displayed in the returned results), the user clicks 1310 “Get my answer” to return the results.

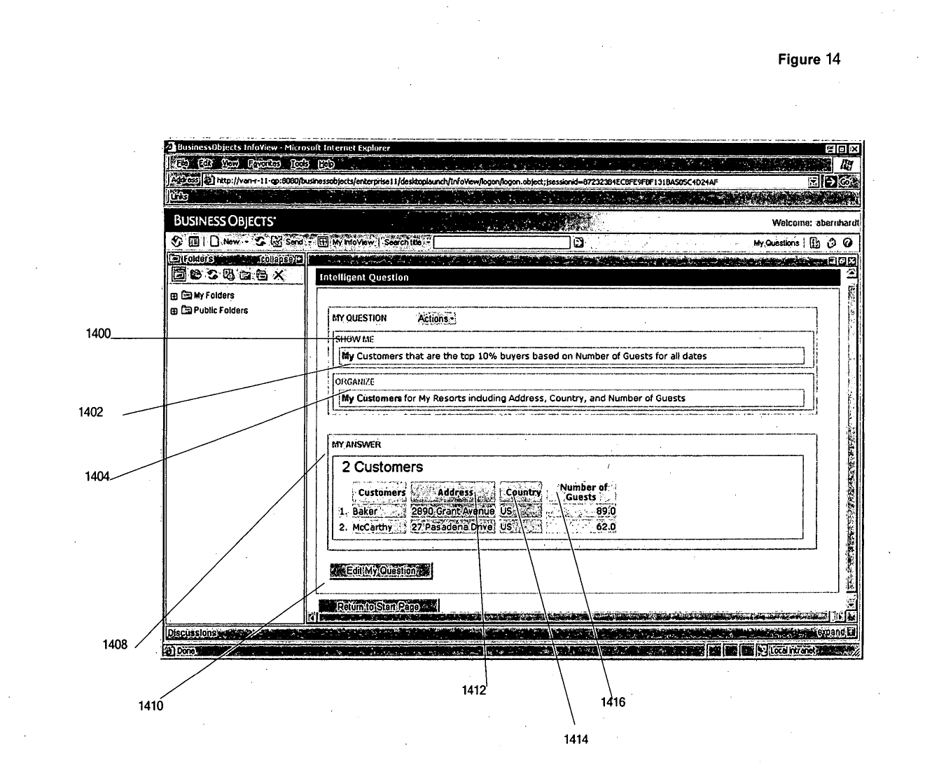

FIG. 14 illustrates the GUI for the query results being returned. At this point the user also has action options to view the SQL that was generated, or export this report to more sophisticated report formats. FIG. 14 illustrates a query in block 1400. An organize block 1404 allows a user to specify an organizational schema for the retrieved data. Block 1408 illustrates a formatted answer block. The answer includes address 1412, country 1414, and number of guests 1416 fields. The functions of this GUI are fully disclosed in the commonly owned and concurrently filed patent application entitled, “Apparatus and Method for Deterministically Constructing a Text Question for Application to a Data Source”, Ser. No. ______, filed Apr. 7, 2005, the contents of which are incorporated herein by reference.

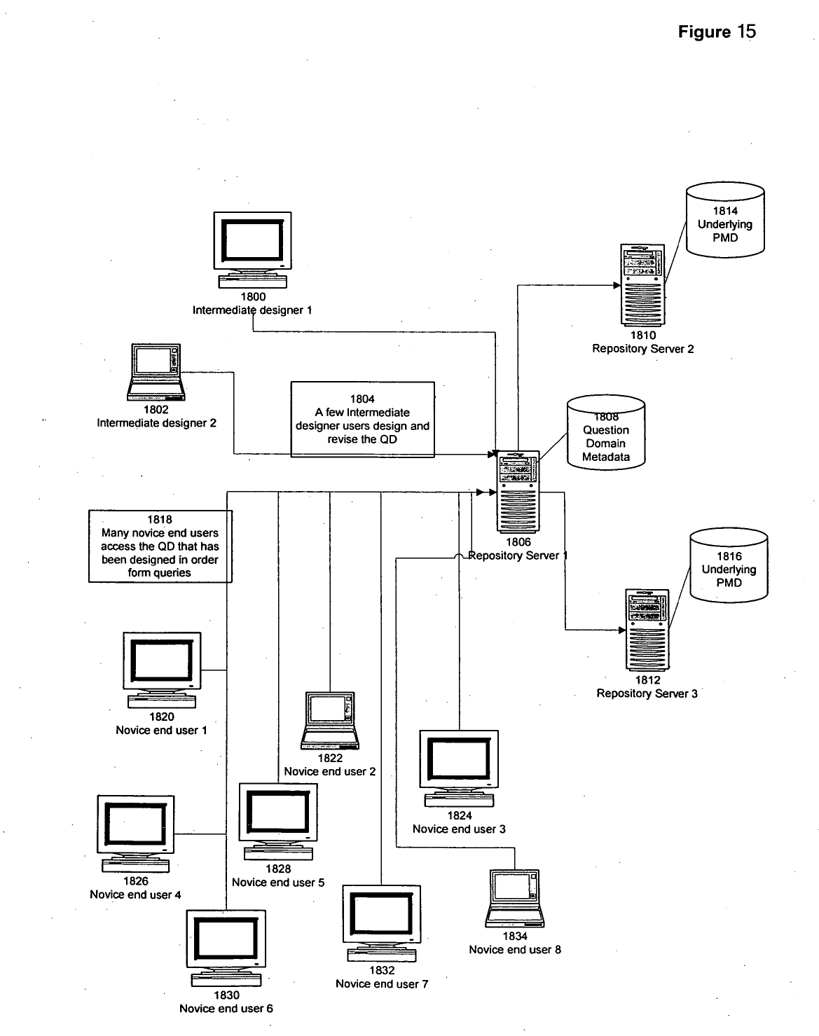

FIG. 15 illustrates various users and how they interact with the system. There are intermediate users who are question domain designers 1800-1802. There can be any number of these intermediate users, but the system is designed so that a few intermediate users 1800-1802 create question domains 1808 that support a much greater number of novice end users 1820-1834. The interaction that the intermediate users have 1804 with the question domain is to design and revise the question domain. Thus, for example, executable instructions or code to implement the operations of FIG. 1 are stored on one or more of the repository servers 1810, 1806, and 1812. These servers may also store executable instructions to present the graphical user interfaces of FIGS. 5 through 14.

The interaction that the novice end users have 1818 with the question domain is to access a question domain that has already been created in order to form queries, such as shown in FIGS. 13 and 14. The figure also illustrates that several servers may be involved and that the question domain 1808 may be stored on a different server than the primitive metadata domains 1814 and 1816. Any number of potential configurations may be used in accordance with the invention; this figure illustrates one possible configuration. The operations of the claimed invention are significant, although the particular location and form of executable code to implement these operations is not significant.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium including executable instructions to associate text sentence components with metadata, comprising executable instructions to:
specify a subject that has a definition corresponding to a metadata source;
identify a behavior that has a definition corresponding to a metadata source; and
associating said behavior with at least one subject, said behavior and at least one subject allowing a user to create a text question convertible to a query to a data source associated with a metadata source.

2. The computer readable medium of claim 1 wherein said executable instructions to identify a behavior include executable instructions to identify a measure corresponding to a metadata source.

3. The computer readable medium of claim 1 wherein said executable instructions to identify a behavior include executable instructions to identify a date corresponding to a metadata source.

4. The computer readable medium of claim 1 wherein said executable instructions to identify a behavior include executable instructions to operate a filter associated with said behavior.

5. The computer readable medium of claim 1 wherein said executable instructions to identify a behavior include executable instructions to process a context referenced by said behavior.

6. The computer readable medium of claim 1 further comprising executable instructions to process the relationship between said subject and said behavior as specified by a term in a graphical user interface.

7. The computer readable medium of claim 1 further comprising executable instructions to process a subject key and a subject label corresponding to a metadata source.

8. The computer readable medium of claim 1 further comprising executable instructions to process a subject attribute corresponding to a metadata source.

9. A computer readable medium including executable instructions to associate text question sentence components with metadata, comprising executable instructions to:
identify metadata characterizing information in a database; and
link text question sentence components to said metadata.

10. The computer readable medium of claim 9 further comprising executable instructions to link a subject of a text question to said metadata.

11. The computer readable medium of claim 10 further comprising executable instructions to link a behavior associated with a subject of said text question to said metadata.

12. The computer readable medium of claim 11 further comprising executable instructions to allow said subject and said behavior to be subsequently selected to form a text question that is convertible to a database query.

13. The computer readable medium of claim 11 further comprising executable instructions to associate a plurality of subjects with said behavior.

14. The computer readable medium of claim 9, wherein said executable instructions to link include executable instructions to associate a behavior with data in said data source.

15. The computer readable medium of claim 14, wherein said executable instructions to associate include executable instructions to associate a measure, date, and context with data in said data source.

16. The computer readable medium of claim 9, wherein said executable instructions to link include executable instructions to associate a subject with data in said data source.

17. The computer readable medium of claim 16, wherein said executable instructions to associate include executable instructions to associate a key, label and attribute with data in said data source.

18. The computer readable medium of claim 9 further comprising executable instructions to identify metadata characterizing information in a plurality of data sources.

19. The computer readable medium of claim 9 further comprising executable instructions to allow a first user to select primary metadata domains from a question domain editor.

20. The computer readable medium of claim 19 further comprising executable instructions to allow said first user to select text question subject components within said question domain editor.

21. The computer readable medium of claim 19 further comprising executable instructions to allow said first user to select text question behavior components within said question domain editor.

22. The computer readable medium of claim 21 further comprising executable instructions to allow a second user to select said text question subject components and said text question behavior components to produce a text question for translation to a structured query to said data source.
